(19) United States
(12) Patent Application Publication
(10) Pub. No.: US 2007/0078563 A1
(43) Pub. Date: Apr. 5, 2007

(54) Interactive system and method for controlling an interactive system

(76) Inventors: Matthew David Harris, Aachen (DE); Vasanth Philomin, Stolberg (DE); Eric Thelen, Aachen (DE)

Correspondence Address: PHILIPS INTELLECTUAL PROPERTY & STANDARDS, P.O. BOX 3001, BRIARCLIFF MANOR, NY, 10510, US

(21) Appl. No.: 10/577,759

(22) PCT Filed: Oct. 19, 2004
(86) PCT No.: PCT/IB04/52136

§ 371 Date: Apr. 28, 2006

(30) Foreign Application Priority Data
Oct. 28, 2003 (EP) 03 103 994.4

(51) Int. Cl. G06F 19/00

(52) U.S. Cl. 700/245

(57) ABSTRACT

The invention describes an interactive system (1) comprising interacting means (2) and control means (6) for controlling the interacting means (2). The control means (6) are responsive to control parameters. The control parameters comprise an inherited parameter (IP) and an interaction parameter, wherein the inherited parameter (IP) is constant, wherein the interaction parameter is influenced by an external factor (EF), and wherein the influence of the external factor (EF) on the interaction parameter is dependent on the inherited parameter (IP).

The invention relates to an interactive system and a method for controlling an interactive system.

Rapid technological advancements in the area of communication electronics has led in recent years to the development of interactive systems, which can interact with users of the interactive systems. Interactive systems usually communicate with their environments via one or more input and output modalities. The system behaviour may range from a fixed, predetermined response to allowable input, to responses that vary in time and can change depending on the system's past experiences and the current circumstances. Among the widespread interactive systems currently available, speech dialog systems in particular are able to interpret the user's speech and to react accordingly, for example by carrying out a task, or by outputting visual or acoustic data. Besides speech dialog systems, worldwide development efforts are now focussed on robot-like interactive systems which are, for example, equipped with sensors, displays and cameras as interacting means.

One of the aims in the development of interactive systems is to design a most intuitive and natural manner and method of interaction for the user. Usability labs have been founded for just this purpose, in which the interaction of users with newly developed interactive systems is observed and analysed in order to optimise the behaviour of the interactive systems to best suit the requirements of the user.

Developmental efforts to date have been generally limited to presenting the output of an interactive system in a form easily understood by the user, and making the input of the user's selection as easy as possible. The interface between user and interactive system is known as a man-machine interface. This emphasises the fact that developments are at present still focussed on improving the interaction between humans and machines.

It is an object of the invention to provide an user friendly interactive system and a method for controlling an interactive system.

To this end, the interactive system according to the invention comprises an interacting means and a control means for controlling the interacting means. The control means is responsive to control parameters, which comprise one or more inherited parameters and one or more interaction parameters. The inherited parameters are constant and the interaction parameters are influenced by an external factor. The influence of the external factor on the interaction parameter is at least partly or entirely dependent on the inherited parameter.

The interacting means preferably comprise anthropomorphic depictive means. It may comprise means to depict a person, an animal, or even a fantasy figure, e.g. a robot.

Preferably, a human face is depicted, whereby the depiction may be realistic or merely symbolic in appearance. In the case of a symbolic representation, it may be that only the outlines of eyes, nose or mouth etc. are rendered. If the depiction is displayed on a computer monitor, the appearance of the interacting means, e.g. facial parameters, colours, hair type etc. may easily be changed. If the depiction is a physical entity, for example in the form of a puppet, the appearance of the interacting means can be physically adjusted. For example, the hair colour and type can be altered by initiating chemical reactions in the “hair” by adjusting a voltage, while facial configurations can be adjusted by mechanical means.

The interacting means can be mechanically moveable, and serve the user as an embodiment of a dialog partner. The actual physical form of such interacting means can take on any one of various embodiments. For example it might be a casing or housing which, as opposed to the main housing of the interactive system, is rendered in some way moveable. The interacting means can present the user with a recognisable front aspect. When this aspect faces the user, he is given the impression that the device is “paying attention”, i.e. can respond to spoken commands.

The interacting means preferably has some way of determining the position of the user. This might be achieved by means of acoustic or optical sensors. The motion of the interacting means is then controlled such that the front aspect of the interacting means is moved to face the user. The user is thus given the impression that the interactive system is attentive and “listening” to him.

Preferably, the interacting means also comprise a means to output a speech signal. Whereas speech recognition is relevant for interpreting input commands for controlling an electronic device, the replies, confirmations and requests are issued using a speech output means. This might be the output of previously stored speech signals or newly synthesized speech. Using speech output means, a complete dialog control can be realised. A dialog can also be carried out with the user for the purpose of entertainment.

In a preferred embodiment of the invention, the interacting means comprise a number of microphones and/or at least one camera. Recording speech input signals can be achieved with a single microphone. However, by recording the user's speech with more than one microphone, it becomes possible to pinpoint the position of the user. A camera allows observation of the surrounding environment. Appropriate image processing of a picture taken by the camera allows the position of the user to be located. In the case of an interacting means configured to resemble a human head, cameras can be installed in the locations given over to the “eyes”, a loudspeaker can be positioned in the “mouth”, and microphones can be located in the “ears”.

The interactive system can be part of an electrical device. Such a device might be, for example, a home-entertainment electrical device (e.g. TV, VCR, cassette recorder) or an electronic toy. In such cases, the interactive system is preferably realised as the user interface of the device. The device may also feature a further user interface, such as a keyboard. Alternatively, the interactive system according to the present invention might also be an independent device acting as a control device to control one or more separate electrical devices. In this case, the devices to be controlled feature an electrical control interface (e.g. radio-controlled, wireless, or by means of an appropriate control bus), by which the interactive system controls the devices according to commands (spoken or otherwise) issued by the user.

In particular, the interactive system of the present invention serves as an interface between a user and a means for data storage and/or retrieval. Here, the data storage/retrieval means preferably features local data memory capacity, or can be connected to an external data memory, for example over a computer network or via the internet. By means of an appropriate dialog, the user can cause data to be stored (e.g. telephone numbers, memos etc.), or can retrieve data (e.g. the time, news items, current TV program listing etc.).

Control of the interacting means of the present invention is effected by two types of control parameters—constant inherited parameters and changeable interaction parameters—in a manner analogous to their influence on human behaviour.

Inherited parameters remain constant, particularly after initialisation, after a re-initialisation or after reset, and are therefore suitable to describe human-like features which also remain unchanged under external influences. The phrase “inherited parameters” is intended to mean all types of parameters that are either passed from one device to another, or are written to the memory of the device during the manufacturing process.

If the interacting means comprises human- or animal-like interacting aspects, e.g. the head or the face of a person or animal, or parts thereof such as nose, eyes, hair, lips etc., the inherited parameters are particularly suitable for the representation of biometric parameters, for example length and shape of the nose, eye colour, hair colour, size of the lips etc.

Depending on the type and extent of the interacting means, inherited parameters are also suitable for the representation of inherited traits such as natural aggression, natural introversion, learning capabilities etc., or the natural reactions of the interactive means to external influences.

Changeable interaction parameters, on the other hand, can be influenced by external factors and are suitable for the description of human-like features that also can be modified by external factors. Depending on the type and extent of the interacting means, for example the following human-like features can be represented by interaction parameters: mood, vocabulary, social interaction style—which might depend upon with whom the interactive system is currently interacting, changes in how the interactive system looks (e.g. a split lip, high colour owing to anger), or sounds, for example rapid, loud breathing to indicate exertion. External factors are registered, for example, by the interacting means, particularly sensors. A particular type of external factor is the behaviour of the user or the behaviour of the interacting means of another interactive device. In the latter case, an interactive system with particular preferred properties can be used to “raise” or “bring up” another interactive system.

Unlike other known interactive systems, which aim to improve the interaction between human and machine, the present invention demonstrates configuration of the control means of an interactive system in such a way that the interactive system behaves in a human-like manner. The focus of the invention therefore rests more on the interactive system than on the interface between user and machine. Compared to the directions taken in development to date, a new and more fundamental approach is taken. The present invention allows the interactive system to exhibit human-like features, which lead to a human-like behaviour of the interactive system of the present invention. This automatically leads to a more natural, intuitive and user-friendly interface between the interactive system and the user. The invention allows the creation of interactive systems, of which each is unique and possesses a unique manner of learning and adapting itself to its surroundings.

The initialisation or re-initialisation of the inherited parameter is preferably based on an inherited parameter of one or more further interactive systems. The human-like features of an interactive system are therefore based on inherited information, in this case the inherited parameters, which one or more other interactive systems bestows on the interactive system in question. In this way, new interactive systems can be created, whose properties and behaviour resemble existing interactive systems. This makes it easier for the user to change from a familiar interactive system to a new interactive system, which has the particular advantage that the user can interact with the new interactive system in the by now familiar way, and can operate it as usual.

According to other embodiments of the invention the initialisation of the inherited parameter based on a random combination from inherited parameters of two or more further interactive systems, or the initialisation of the inherited parameter is based on a random modification of a further interactive system. This has the advantage that no one interactive system behaves like another.

Analogous to the possibilities for initialising the inherited parameters of an interactive system, the interaction parameters can also be initialised, for example when purchasing, but can, unlike inherited parameters, be later modified by external factors.

Along with an interactive system, the invention also comprises a method for controlling an interactive system. Further developments of the method claims corresponding to the dependent claims of the system claim also lie within the scope of the invention.

Other objects and features of the present invention will become apparent from the following detailed descriptions considered in conjunction with the accompanying drawings. It is to be understood, however, that the drawings are designed solely for the purposes of illustration and not as a definition of the limits of the invention, for which reference should be made to the appended claims.

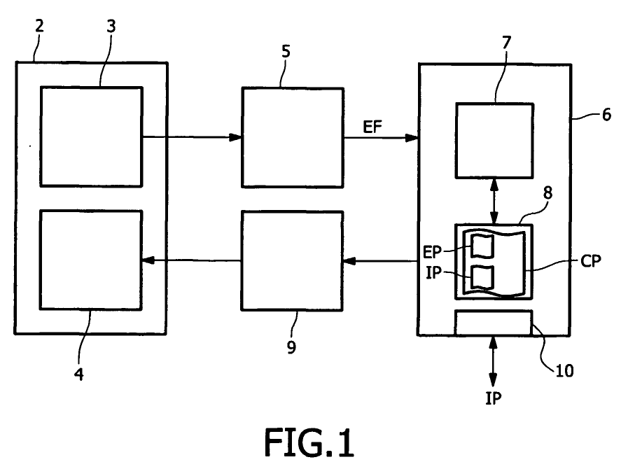

FIG. 1 is a block diagram of an interactive system,

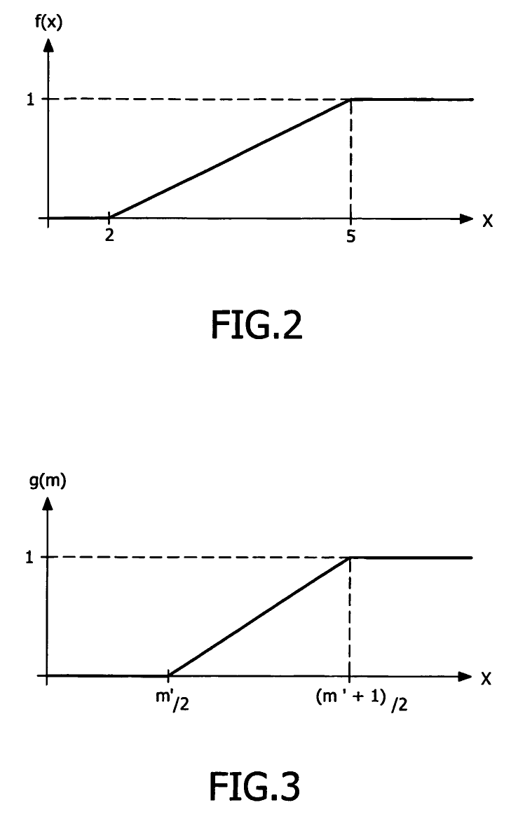

FIG. 2 shows a distribution function P(X<x)=f(x),

FIG. 3 shows a cumulative distribution function g(x).

The block diagram of FIG. 1 shows an interactive system 1 comprising an interacting means 2 and a control means 6. The interacting means 2 comprise an input sensor subsystem 3 and an output modalities subsystem 4. The input sensor subsystem 3 consists of an input device for speech, e.g. a microphone; an input device for video signals, e.g. a camera; and a text input device, e.g. a keyboard. The output modalities subsystem 4 consists of an output for speech e.g. a loudspeaker; a video output e.g. a graphical display; and an output for a pointing device e.g. an artificial finger, a laser pointer etc. Furthermore, the output modalities subsystem 4 is endowed with a certain human-like physical features, (hair-colour, skin-colour, odour etc.).

Input signals to the input sensor subsystem 3 are subjected in an input analysis module 5 to speech analysis, gesture analysis and/or content analysis. Corresponding external factors EF are extracted or deduced from the input signals and furthered to the control means 6.

For the purposes of interaction management, the control means 6 are essentially divided into the logical functional blocks “knowledge representation”, “input response planning”, and “mood and internal state management”. The control means 6 are realised mainly by a processor arrangement 7 and an associated memory device 8.

Interaction and inherited parameters are stored in the memory device 8. The interaction parameters EP are updated by the above-mentioned functional blocks according to the current external factors EF, continually or at fixed or variable discrete time intervals. The continually updated interaction parameters EP, along with the inherited parameters IP stored in memory, together give at least a subset of the control parameters CP which are applied in an output management module 9 to control the interacting means. The control parameters CP hereby influence the properties and the behaviour of the interacting means 2 and also of the entire interactive system 1.

For example, in order to control the output vocabulary of the interacting means 2, synonym weight parameters are provided as interaction parameters EP, which determine which of several possible synonyms for a word, e.g. large, huge, gigantic, humungous, mega, whopping, are to be used. The weight parameters are in turn influenced by the above-mentioned external factors EF.

Equally, sentence construction parameters are provided as interaction parameters EP to determine which grammatical structures are preferred and whether they are to be applied to text and/or speech output. By adapting the sentence construction parameters by the external factors EF, it is possible for the interactive system to learn and apply the same grammar as an interactive partner, e.g. a human user.

Mood parameters are used as interaction parameters in order to influence the next internal state change of the interactive system. For example, the mood parameters can determine whether a user's command is ignored, receives a rude answer, or is answered politely. Mood parameters can also be used to influence other interaction parameters such as synonym weight parameters or sentence construction parameters.

Opinion parameters as interaction parameters can describe, for example, the opinion the interactive system has about a user, about a certain topic, or about a certain task that it should carry out. Opinion parameters can influence, for example, the mood and therefore also the synonym weight parameters or sentence construction parameters. On the other hand, mood parameters can also influence the opinion parameters.

Natural characteristic parameters, which influence the interaction parameters described previously, are also provided. For example, mood swing parameters describe how often and to what extent mood swings are likely to occur. Aggression parameters describe the likelihood of the interactive system to exhibit aggressive behaviour. Obedience parameters determine the extent to which the interactive system obeys the user and learns to understand what the user wants. IQ parameters represent the intelligence of the interactive system, and therefore also how quickly and how well the interactive system learns. Appearance parameters represent, for example, facial dimensions, colour, hair type etc.

The inherited parameters IP can be initialised, for example when purchasing the interactive system, by means of a parameter interface 10, or can be re-initialised at a later date to some other values, or reset to the original values. For such initialisation, the following embodiments are provided by the invention:
The inherited parameters are a direct copy of another existing interactive system.
The inherited parameters are set randomly without input from a parent interactive system.
The inherited parameters are set to that of one a set of standard interactive systems.
The inherited parameters are a randomly modified copy of the inherited parameters of one parent interactive system.
The inherited parameters of two parent interactive systems are combined in a defined way (without randomisation).
The inherited parameters from two parent interactive systems are combined in a random way, particularly with some influence from the position of the stars, sun, and planets. This means that the interactive system inherits characteristics from its parent interactive systems, but is not identical to them. Also, due to the random component, each child of the same two parent systems will be different.

In a possible realization of inherited parameters generation in the method according to the last example, a merging step is used before randomisation. The randomisation is then carried out with one input parameter set. This is described by means of an example in the following. For the sake of simplicity only the case of just one inherited parameter (e.g. nose length) is considered. Random variable X is defined to be the inherited parameter (nose length) with the cumulative distribution function P(X<x)=f(x) as shown in FIG. 2. The function f(x) gives the distribution of the random variable in the whole population. FIG. 2 shows the cumulative distribution function for a parameter, whose probability distribution is in the form of a rectangle. Many inherited parameters, such as nose length, are best represented by a Gaussian probability distribution. However, for the sake of clarity, a cumulative distribution function as in FIG. 2 will be assumed in the following:

A merging step comprises the following partial steps:

The inherited parameter x1 of the first parent interactive system gives the parameter x1′:
x1′=f(x1).

The inherited parameter x2 of the second parent interactive system gives the parameter x2′:
x2′=f(x2).

Using x1′ and x2′, an intermediate merged inherited parameter m′ is determined by the following equation:
m′=(x1′+x2′)/2.

The inverse function of f(x) is applied to m′ to derive the merged inherited parameter m:
m=f⁻¹(m′).

In summary, the merged inherited parameter m can be expressed as follows:
m=f⁻¹((f(x1)+f(x2))/2).

Using the cumulative distribution function in this way ensures a realistic value of the merged inherited parameters. Of course other distribution functions can also be used which reflect the distribution of inherited parameters within a population. Distribution functions based on a Gaussian distribution are particularly suitable for describing the probability of the occurrence of human-like features within a population.

In a second step, this merged parameter m is subjected to a randomisation.

To generate a merged parameter y after randomisation, consider m′=f(m). Now draw y′ from the distribution with the cumulative distribution function g (m) as shown in FIG. 3 and define y=f⁻¹(y′) to find the randomised merged inherited parameter with value near m.

The last randomisation step can also be used to randomise an inherited parameter taken from one parent interactive system only, regardless from which.

In order to create several inherited parameters based on the inherited parameters of two other interactive systems a multi-dimensional version of the one parameter example given could be carried out. The functions f and g are then functions of more than one variable.

An initialisation of the inherited parameters can be carried out in an inherited parameters generation unit specifically designed for this purpose, which receives the input inherited parameters from the parent interactive systems and gives the new child inherited parameters as output. Equally, a physical realisation of the initialisation of the inherited parameters of an interactive system is possible using only parent interactive systems and child interactive systems without additional hardware, insofar as the interactive systems are equipped accordingly. The transfer of inherited parameters between child interactive system, parent interactive system or inherited parameters generation unit can be realised in form of an infrared, bluetooth or an actual physical parameter interface 10. Such a physical parameter interface can be given a special construction, to make the creation of a new system inherited parameter more graphic. It may also be desirable at some point to override or adjust some inherited parameters.

Although the present invention has been disclosed in the form of preferred embodiments and variations thereon, it will be understood that numerous additional modifications and variations could be made thereto without departing from the scope of the invention. For example, the distribution functions described are merely examples, which can be adapted or modified by one skilled in the art without leaving the scope of the invention.

For the sake of clarity, it is to be understood that the use of “a” or “an” throughout this application does not exclude a plurality, and “comprising” does not exclude other steps or elements.

1. An interactive system (1),—the interactive system (1) comprising interacting means (2) and control means (6) for controlling the interacting means (1),
the control means (6) being responsive to control parameters (CP),
the control parameters comprising an inherited parameter (IP) and an interaction parameter (EP),
wherein the inherited parameter (IP) is constant,
wherein the interaction parameter (EP) is influenced by an external factor (EF), and
wherein the influence of the external factor (EF) on the interaction parameter (EP) is dependent on the inherited parameter (IP).

2. A system as claimed in claim 1, wherein the inherited parameter (IP) is constant after an initialisation.

3. A system as claimed in claim 2, wherein the initialisation of the inherited parameter (IP) is based on an inherited parameter (IP) of one or more further interactive systems.

4. A system as claimed in claim 3, wherein the random combination comprises a merging step, in which the inherited parameters (IP) of two or more further interactive systems are merged.

5. A system as claimed in claim 3, wherein the initialisation of the inherited parameter (IP) is based on a random combination from inherited parameters (IP) of two or more further interactive systems.

6. A system as claimed in claim 3, wherein the initialisation of the inherited parameter (IP) is based on a random modification of an inherited parameter (IP) of a further interactive system.

7. Method for controlling an interactive system (1) comprising interacting means (2) and control means (6) for controlling the interacting means (2),
wherein the control means (6) respond to control parameters,
wherein the control parameters comprise an inherited parameter (IP) and an interaction parameter,
wherein the inherited parameter (IP) is constant,
wherein the interaction parameter is influenced by an external factor (EF), and
wherein the influence of the external factor (EF) on the interaction parameter depends on the inherited parameter (IP).

8. A robot device comprising interacting means (2) and control means (6) for controlling the interacting means (2), the control means (6) being arranged such,
that the control means (6) respond to control parameters,
that the control parameters comprise an inherited parameter (IP) and an interaction parameter,
that the inherited parameter (IP) is constant,
that the interaction parameter is influenced by an external factor (EF), and
that the influence of the external factor (EF) on the interaction parameter depends on the inherited parameter (IP).
